(19) United States
(12) Patent Application Publication
(10) Pub. No.: US 2009/0278478 A1
(43) Pub. Date: Nov. 12, 2009

(54) DC voltage converter

(76) Inventor: Ting Huei Chen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/222,242

(22) Filed: Aug. 6, 2008

(30) Foreign Application Priority Data
May 12, 2008 (TW) 97117375

(51) Int. Cl. H02M 3/335; H05B 37/02

(52) U.S. Cl. 315/308; 363/21.11

(57) ABSTRACT

A DC voltage converter used for producing a driving voltage to drive a load comprising a step-up circuit and a modulation circuit is provided. The step-up circuit is used for receiving an input voltage and boosting the input voltage to produce an output voltage. The output voltage is controlled according to a feedback voltage indicative of state of the load. The modulation circuit is electrically connected to the step-up circuit and transforms the output voltage into the driving voltage with a higher voltage level so as to further increase the voltage level of the already boosted output voltage.

### BACKGROUND OF THE INVENTION

1. Field of the Invention

The present invention relates to a direct current (DC) voltage converter; in particular, to a DC voltage converter adopting fixed current design and used for boosting the voltage.

2. Description of Related Art

In recent years, thanks for the striding development of technologies, types of available electronic devices and their respective applications grew rapidly. It is understood that the power source is one of the most fundamental factors for the operations of electronic devices. The quality of the power source will affect the operation and performance of the overall electronic devices.

Generally, in terms of power source design for electronic devices, it is common to use converters, such as a DC/DC voltage converter, to perform voltage transformation for the need of driving the load. Among electronic devices in present, take the popular high-power white-light-emitting-diode (WLED) for example, it needs a DC voltage booster to increase the voltage level of the input voltage to generate the required driving voltage for driving the WLED.

Refer now to FIG. 1, wherein a circuit diagram of a prior art DC voltage booster is shown. As illustrated, the DC voltage booster 9 has a pulse-width modulation control unit 91, a voltage dividing circuit 92, an inductor L, a diode D and a capacitor C. Therein the pulse-width modulation control unit 91 has a power transistor Q. The operation of the power transistor Q is controlled by a gate voltage V_{G}.

When the power transistor Q is in conducting state, the diode D is reverse-biased, and the current generated by the input voltage V_{IN} flows forward to the inductor L to increase the current passing through the inductor L so as to store energy in the inductor L. Also, the output voltage V_{OUT} at this time is provided by the capacitor C.

In contrast, when the power transistor Q is in off state, the inductance current continues and the polarity of the inductor L is reversed so as to release the energy stored therein to charge the capacitor C, and meanwhile provide the output voltage V_{OUT} for driving the load (e.g. the white light emitting diode).

Furthermore, the DC voltage booster 9 adopts fixed voltage design. The voltage dividing circuit 92 of the DC voltage booster 9 has resistors R1, R2 coupled in series to the output end of the DC voltage booster 9 for performing voltage division on the output voltage V_{OUT} and generating a feedback voltage (FB) at a voltage division point to the pulse-width modulation control unit 91, such that the pulse-width modulation control unit 91 may control the operation of the gate voltage V_{G} based on the feedback voltage (FB) to achieve the purpose of the fixed voltage design.

However, the preferred conversion ratio (V_{OUT}/V_{IN}) of the DC voltage booster 9 is generally below 3. The output voltage V_{OUT} is limited by the input voltage V_{IN}, and the input voltage V_{IN} is limited by the withstanding voltage of the power transistor Q itself. Thus, the prior art DC voltage booster 9 cannot be applied to a circumstance requiring a higher driving voltage. Therefore, when a designer intends to design a booster to drive loads requiring a higher driving voltage (for example, more white-light-emitting-diodes connected in a serial), it is necessary to select a pulse-width modulation control unit 91 incorporating with a power transistor Q having greater withstanding voltage. In particular, the approach integrating the power transistor Q in the pulse-width modulation control unit 91 as a single control chip may further increase complexity in both design and fabrication.

### SUMMARY OF THE INVENTION

In view of the above-illustrated issues, it is a main object of the present invention to make an improvement on the output portion of the step-up circuit in the DC voltage converter by designing a modulation circuit to transform the original output of the DC voltage converter into a higher driving voltage so as to resolve the above mentioned problems. Therefore, the range of driving voltage outputted by the DC voltage converter according to the present invention would not be limited by the withstanding voltage of the power transistor in the original pulse-width modulation control unit so as to effectively enhance the voltage level of the output voltage to fulfill the demand for driving loads requiring a higher driving voltage. Thereby the applicability and practicability of the DC voltage converter may be increased. In addition, since the object of the present invention is accomplished with simple circuitry design, product cost can be significantly reduced.

To achieve the aforementioned purposes, one proposed solution according to the present invention provides a DC voltage converter generating a driving voltage to drive a load. The DC voltage converter comprises a step-up circuit and a modulation circuit, wherein the step-up circuit is used to receive an input voltage and to increase the input voltage in order to generate an output voltage and further adjust the output voltage based on a feedback voltage representing the state of the load. The modulation circuit is coupled to the step-up circuit and transforms the output voltage into the driving voltage with a voltage level higher than that of the output voltage.

Thereby, the output voltage of the DC voltage converter would not be limited by the withstanding voltage of the power transistor in the step-up circuit. It is possible to further increase the voltage level of the output voltage of the original step-up circuit so as to meet the requirement for driving loads requiring a higher driving voltage. Additionally, the DC voltage converter in accordance with the present invention also has the advantage of releasing the limitation about power transistor withstanding voltage.

The above-mentioned summary and subsequent detailed descriptions as well as appended drawings are all illustrations of approaches, means and effects adopted by the present invention to achieve the prescribed purposes. Other objectives and advantages related to the present invention will be further elucidated in the following specification and diagrams.

### BRIEF DESCRIPTION OF THE DRAWINGS

FIG. 1 is a circuit diagram of a prior art DC voltage booster;

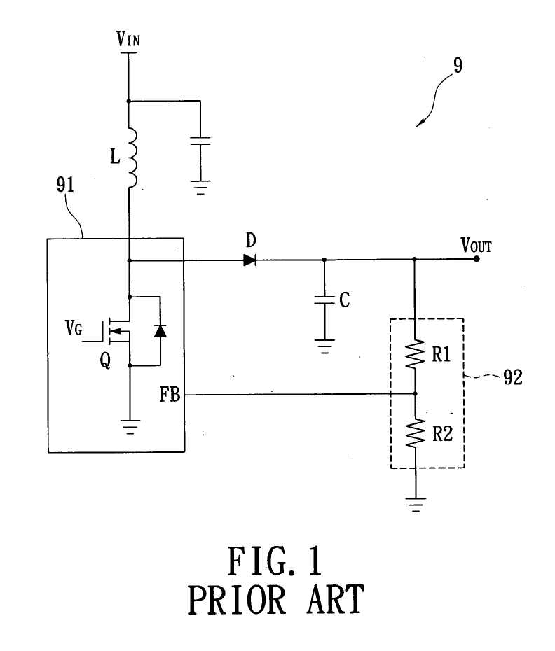

FIG. 2 is a block diagram of an embodiment of the DC voltage converter according to the present invention;

FIG. 3A is a circuit diagram of a first embodiment of the DC voltage converter of FIG. 2 according to the present invention;

FIG. 3B is a waveform diagram showing the operation of the first embodiment of the DC voltage converter according to the present invention;

FIG. 4 is a circuit diagram of a second embodiment of the DC voltage converter of FIG. 2 according to the present invention; and

FIG. 5 is a circuit diagram of a third embodiment of the DC voltage converter of FIG. 2 according to the present invention.

### DETAILED DESCRIPTION OF THE PREFERRED EMBODIMENTS

The present invention focuses on the improvement of the output portion of step-up circuit in the DC voltage converter to modulate the output voltage of the original step-up circuit, such that the driving voltage outputted by the DC voltage converter according to the present invention for driving the load would not be limited by the withstanding voltage of the power transistor of the step-up circuit used for switching and the original output voltage would be increased to fulfill the need for driving a load requiring a higher driving voltage.

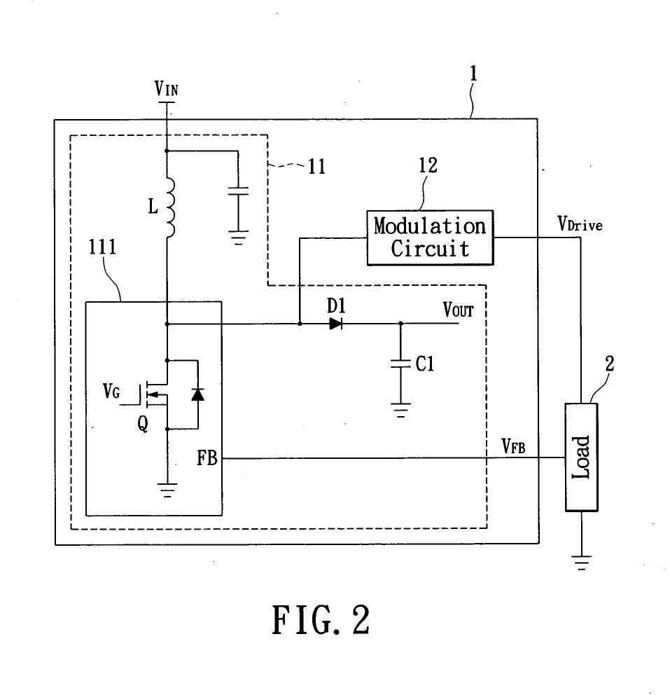

Refer now to FIG. 2, wherein a block diagram of an embodiment of the DC voltage converter according to the present invention is shown. As illustrated, the present embodiment provides a DC voltage converter 1 which is used for generating a driving voltage V_{Drive} to drive a load 2. The DC voltage converter 1 has a step-up circuit 11 and a modulation circuit 12. The step-up circuit 11 receives an input voltage V_{IN}, and is used to increase the voltage level of the input voltage V_{IN} to generate an output voltage V_{OUT}. The modulation circuit 12 may be a charge pump step-up circuit. The step-up circuit 11 further controls the driving voltage V_{Drive} of the DC voltage converter 1 based on a feedback voltage V_{FB} representing the state of the load 2 so as to reach the object of fixed current output. The modulation circuit 12 is coupled to the step-up circuit 11 to transforming the output voltage V_{OUT} into the driving voltage V_{Drive} for driving the load 2. In addition, the operation of the modulation circuit 12 makes the voltage level of the driving voltage V_{Drive} to be higher than the output voltage V_{OUT}.

In detail, which should be understood for those skilled in the art, the step-up circuit 11 has a first capacitor C1, an inductor L, a pulse-width modulation control unit 111 and a first diode D1. The step-up circuit 11 receives the input voltage V_{IN} by using the inductor L so as to have energy stored in and released from the inductor L. The pulse-width modulation control unit 111 may built-in a power transistor Q or couple an external power transistor Q. For example, the power transistor Q can adopt a design of N-type Metal Oxide Semiconductor Field Effect Transistor (N MOSFET). A source/drain of the power transistor Q is coupled to the inductor L. The pulse-width modulation control unit 111 controls the switching between on/off states of the power transistor Q by using a gate voltage V_{G} so as to manipulate charging/discharging operations of both the first capacitor C1 and the inductor L to generating the output voltage V_{OUT}. Furthermore, the positive end of the first diode D1 is coupled a junction between the source/drain of the power transistor Q and the inductor L, and the negative end of the first diode D1 is coupled to one end of the first capacitor C1, while the other end of the first capacitor C1 is grounded, such that the first diode D1 is able to rectify and output the output voltage V_{OUT} and charge the first capacitor C1 as well.

After boosting and converting the input voltage V_{IN} into the output voltage V_{OUT} by means of the step-up circuit 11, the present embodiment may further transform the output voltage V_{OUT} into the driving voltage V_{Drive} by using the modulation circuit 12 so as to enhance the output voltage V_{OUT} and output the driving voltage V_{Drive}. The outputted driving voltage V_{Drive} would not be limited by the withstanding voltage of the power transistor Q in the pulse-width modulation control unit 111, and is thus capable of effectively driving the load 2 that requires a higher driving voltage.

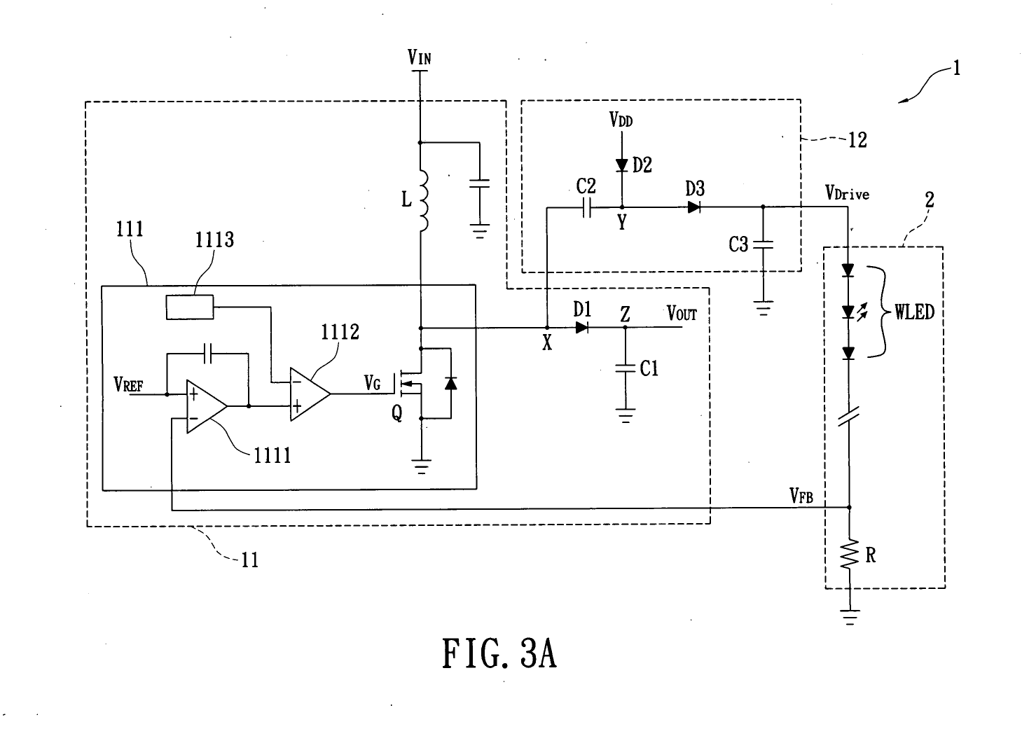

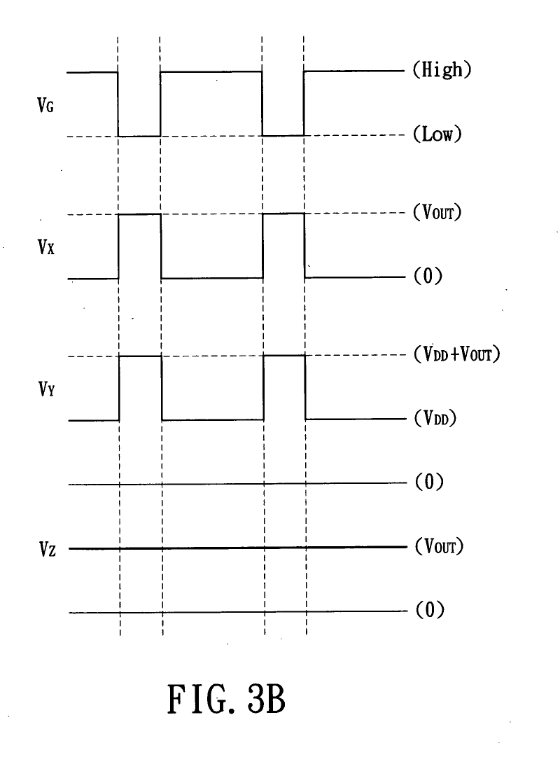

Refer now to FIGS. 3A and 3B, a circuit diagram of the first embodiment of the DC voltage converter and a respective waveform diagram depicting the operation thereof are shown. As illustrated in FIG. 3A, the pulse-width modulation control unit 111 in the step-up circuit 11 further has an error amplifier 1111, a comparator 1112 and a slope generator 1113. The positive input end (+) of the error amplifier 1111 receives a prescribed reference voltage V_{REF}, and the negative input end (−) of the error amplifier 1111 is coupled to load 2 for receiving the feedback voltage V_{FB} representing the state of the load 2, so as to generate an error signal. The positive input end (+) of the comparator 1112 is coupled to the output end of the error amplifier 1111 for receiving the error signal, and the negative input end (−) of the comparator 1112 is used to receive a slope signal outputted from the slope generator 1113. The error signal and the slope signal are further compared by the comparator 1112 to generate the gate voltage V_{G} to control on/off state of the power transistor Q.

From the above-mentioned description, those skilled in the art should be able to appreciate that the pulse-width modulation control unit 111 adjusts the gate voltage V_{G} based on the feedback voltage V_{FB} so as to control the conducting time of the power transistor Q to achieve the object of manipulating the output of the DC voltage converter 1.

Also referring to FIG. 3A, the modulation circuit 12 further has a second diode D2, a second capacitor C2 and a third diode D3. The positive end of the second diode D2 is used to receive a power source voltage V_{DD}. The power source voltage V_{DD} described here may be the input voltage V_{IN}, the output voltage V_{OUT} or the voltage generated by a voltage stabilizer (not shown), which is not intended to limit the scope of the present invention.

Next, the second capacitor C2 has one end thereof coupled to the positive end of the first diode D1 and the other end coupled to the negative end of the second diode D2, so as to receive the power source voltage V_{DD} provided from the forward-biased second diode D2 during charging. The positive end of the third diode D3 is coupled to a junction between the negative end of the second diode D2 and the second capacitor C2, and the negative end of the third diode D3 is coupled to the load 2 and the third capacitor C3, such that the third diode D3 can rectify and output the driving voltage V_{Drive} to the load 2.

As to the description of the operation of the DC voltage converter of the first embodiment, please refer to FIGS. 3A to 3B. It is noted that the power transistor Q used in the present embodiment is an N-type MOSFET as an example. First, when the gate voltage V_{G} is high, the power transistor Q is in conducting state and thus the inductor L is grounded. At the same time, the inductor L begins to store energy since the current flowing through the inductor L increases. Meanwhile, the power source voltage V_{DD} begins to charge the second capacitor C2 until the level of the power source voltage V_{DD} is reached. At this moment, the first capacitor C1 is kept at the voltage level of the output voltage V_{OUT}. Also referring to the waveform diagram in FIG. 3B, that is, when the gate voltage V_{G} is high, voltage at node X (V_{X}) is reduced to zero because the power transistor Q is in conducting state, voltage at node Y (V_{Y}) is identical to V_{DD} because of the supply from the power source voltage V_{DD}, and voltage at node Z (V_{Z}) is identical to V_{OUT}, which is supplied by the first capacitor C1.

Subsequently, when the gate voltage V_{G} is low and the power transistor Q is in off state, the polarity of the inductor L is reversed to release energy so as to generate the voltage level of the output voltage V_{OUT} at the positive end of the first diode D1 and charge the first capacitor C1 through the first diode D1. Additionally, the second capacitor C2, which has the voltage level of the power source voltage V_{DD}, may induce electronic effect on the output voltage V_{OUT} generated at the positive end of the first diode D1, such that the driving voltage V_{Drive} forwardly output by the third diode D3 is identical the sum of the output voltage V_{OUT} and the power source voltage V_{DD}. The relationship between the output voltage V_{OUT}, the power source voltage V_{DD}, and the driving voltage V_{Drive} can be expressed by the following equation:

V_{Drive}=V_{DD}+V_{OUT}

Also referring to the waveform diagram in FIG. 3B, that is, when the gate voltage V_{G} is low, voltage at node X (V_{X}) is identical to the output voltage V_{OUT}, which is created by the magnetic field stored in the inductor L, voltage at node Y (V_{Y}) is identical to the summation of the output voltage V_{OUT} created by the magnetic field stored in the inductor L and the power source voltage V_{DD} stored in the second capacitor (V_{DD}+V_{OUT}), and voltage at node Z (V_{Z}) is identical to V_{OUT} to charge the first capacitor C1.

Thereby, by using the modulation circuit 12 in the present embodiment in conjunction with the switching control of the gate voltage V_{G} in the power transistor Q, it is possible to generate a driving voltage V_{Drive} (V_{DD}+V_{OUT}) with a voltage level higher than that of the original output voltage V_{OUT} so as to drive the load 2 requiring a higher driving voltage.

In practical, the load 2 may comprise at least one white light emitting diode (WLED) and a resistor R connected in a serial. The positive end of the WLED is coupled to the output end of the modulation circuit 12, which is corresponding to the negative end of the third diode D3, so as to receive the driving voltage V_{Drive}. The negative end of the WLED is coupled to one end of the resistor R, and the other end of the resistor R is grounded. In addition, in the step-up circuit 11, the negative input end (−) of the error amplifier 1111 in the pulse-width modulation control unit 111 is coupled to a junction between the negative end of the WLED and the resistor R, in order to receive the feedback voltage V_{FB}.

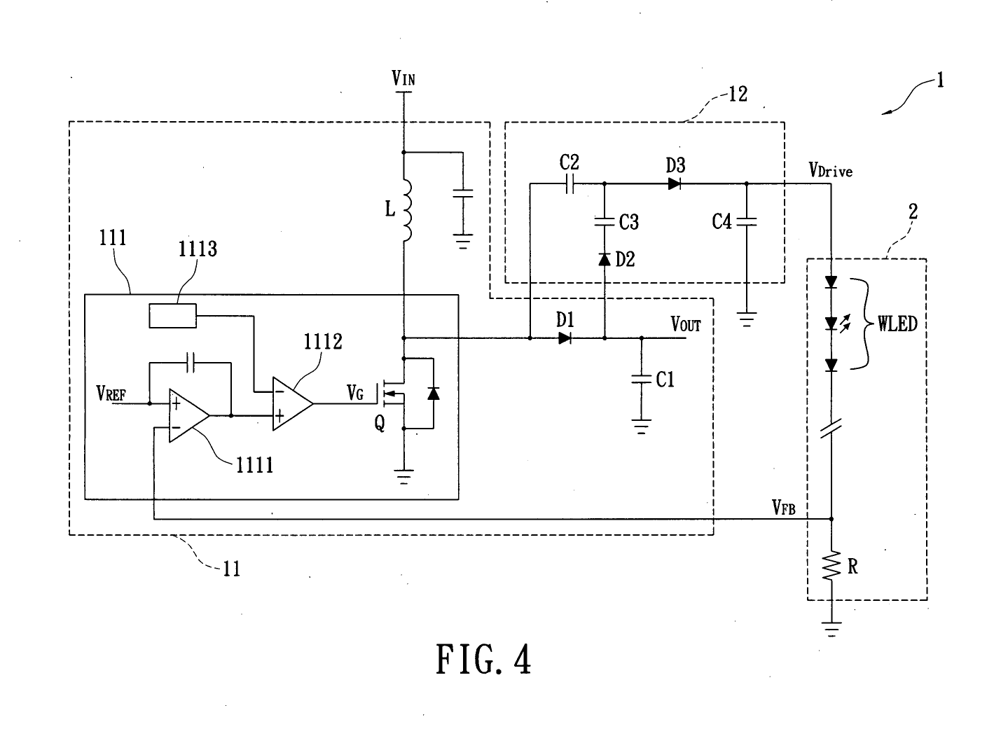

Refer now to FIG. 4, wherein a circuit diagram of a second embodiment of the DC voltage converter according to the present invention is shown. As illustrated, the operation of the inductor L and the pulse-width modulation control unit 111 in the step-up circuit 11 as well as the composition of the load 2 provided in the present embodiment are identical to that of the first embodiment. The major difference between the first embodiment and the second embodiment lies in the circuit design of the modulation circuit 12.

The modulation circuit 12 of the present embodiment has a second diode D2, a third diode D3, a second capacitor C2, a third capacitor C3 and a fourth capacitor C4. The negative end of the third diode D3 is coupled to the load 2, such that the third diode D3 is forward-bias when transferring the driving voltage V_{Drive} to the load 2. One end of the second capacitor C2 is coupled to the positive end of the first diode D1, whereas the other end of the second capacitor C2 is coupled to the positive end of the third diode D3. Furthermore, one end of the third capacitor C3 is coupled to a junction between the second capacitor C2 and the positive end of the third diode D3, the other end of the third capacitor C3 is coupled to the negative end of the second diode D2, while the positive end of the second diode D2 is coupled to the first capacitor C1. One end of the capacitor C4 is coupled to the negative end of the third diode D3, and the other end of the capacitor C4 is grounded.

When the gate voltage V_{G} is high and the power transistor Q is in conducting state, the inductor L is grounded and begins to store energy because the current flowing through the inductor L increases. At this time, the output voltage V_{OUT} provided by the first capacitor C1 charges the third capacitor C3 and the second capacitor C2 via the forward-bias second diode D2. A dividing voltage is generated between the third capacitor C3 and the second capacitor C2.

Next, when the gate voltage V_{G} is low and the power transistor Q is in off state, the polarity of the inductor L is reversed to release energy so as to generate a voltage level of the output voltage V_{OUT} at the positive end of the first diode D1 and charge the first capacitor C1 through the forward-bias first diode D1. In addition, the second capacitor C2 and third capacitor C3 (dividing voltage already formed therein) induces an electronic effect on the output voltage V_{OUT} generated at the positive end of the first diode D1, such that the driving voltage V_{Drive} output by the forward-bias third diode D3 is identical to the sum of the output voltage V_{OUT} plus the dividing voltage. The resulting driving voltage V_{Drive} can be expressed by the following equation:

$${V}_{Drive} = \frac{C 3}{( C 2 + C 3 )} * {V}_{OUT} + {V}_{OUT} = [ 1 + \frac{C 3}{( C 2 + C 3} ] * {V}_{OUT}$$

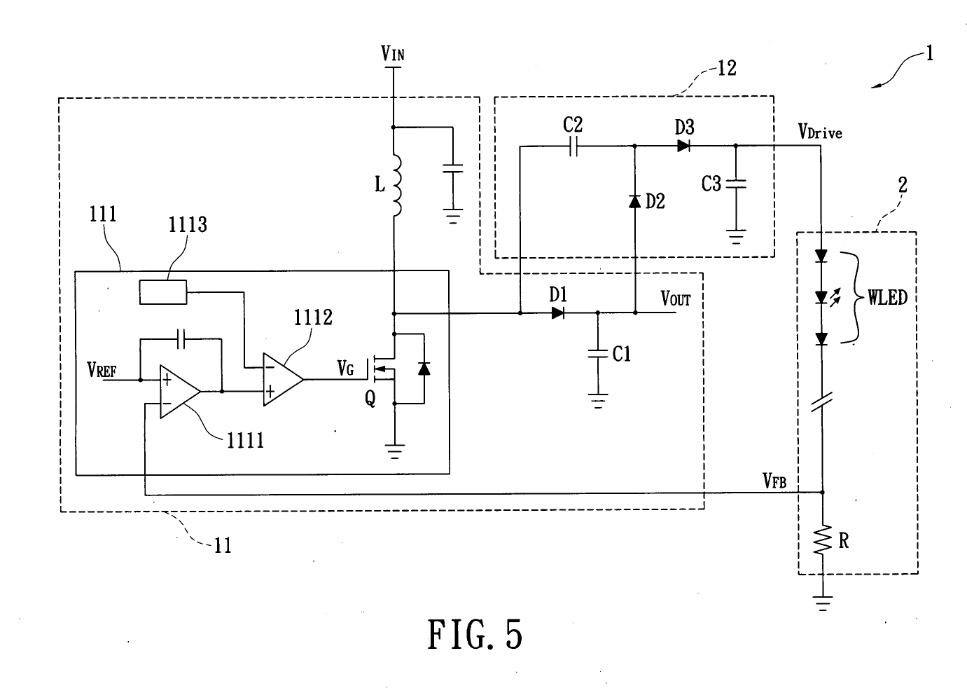

Refer now to FIG. 5, wherein a circuit diagram of a third embodiment of the DC voltage converter according to the present invention is shown. As illustrated, the major difference between the present embodiment and the first embodiment or the second embodiment lies in the design of the modulation circuit 12.

The modulation circuit 12 in the present embodiment has a second diode D2, a third diode D3, a second capacitor C2 and a third capacitor C3. The negative end of the third diode D3 is coupled to the load 2, such that the third diode D3 is forward-bias when transferring the driving voltage V_{Drive} to the load 2. One end of the second capacitor C2 is coupled to the positive end of the first diode D1, and the other end of the second capacitor C2 is coupled to the positive end of the third diode D3, while the negative end of the third diode D3 is coupled to the load 2 and the third capacitor C3. Furthermore, the negative end of the second diode D2 is coupled a junction between the positive end of the third diode D3 and the second capacitor C2, and additionally, the positive end of the second diode D2 is coupled to the first capacitor C1.

When the gate voltage V_{G} is high and the power transistor Q is in conducting state, the inductor L is grounded and begins to store energy. At this time, the output voltage V_{OUT} is provided by the first capacitor C1 through the forward-bias second diode D2 to charge the second capacitor C2 so as to have the second capacitor C2 possess the voltage level of the output voltage V_{OUT}.

Next, when the gate voltage V_{G} is low and the power transistor Q is in off state, the polarity in the inductor L is reversed to release energy stored in the inductor L as a magnetic field, so as to generate a voltage level of the output voltage V_{OUT} at the positive end of the first diode D1 and charge the first capacitor C1 through the forward-bias first diode D1. Also, the second capacitor C2, which processes the voltage level of the output voltage V_{OUT}, induces electronic effect on the output voltage V_{OUT} generated at the positive end of the first diode D1, such that the driving voltage V_{Drive} output by the forward-bias third diode D3 is twice of the output voltage V_{OUT}, which follows the equation shown as below:

V_{Drive}=2*V_{OUT}

In summary of the aforementioned specification, the present invention makes improvement on the output portion of the step-up circuit in the DC voltage converter. That is, the output voltage from the original step-up circuit is further modulated and increased such that the driving voltage output by the DC voltage converter according to the present invention for driving the load would not be limited by the withstanding voltage of the power transistor in the original the pulse-width modulation control unit. Accordingly, the insufficiency in withstanding voltage of the power transistor can be compensated. In addition, the present invention is capable of effectively increasing the already boosted output voltage by transforming the original output voltage to result a higher driving voltage so as to fulfill the need of driving a load requiring a large driving voltage. Additionally, the DC voltage converter provided in the present invention possesses both feasibility and applicability and is applicable to various voltage boosting designs, such as the drive of the popular WLEDs. Furthermore, since the present invention can be accomplished by simple hardware circuit, it processes the advantage of low design cost.

The above-mentioned specification presents merely the detailed descriptions of the embodiments of the present invention and appended drawings, which is by no means to limit the present invention thereto. The scope of the present invention should be based on the subsequent claims, and any changes or modifications that skilled ones in the relevant arts can conveniently consider within the field of the present invention are all deemed to be encompassed by the scope of the present invention delineated by the claims set out hereunder.

What is claimed is:

1. A DC voltage converter, which is used to generate a driving voltage to drive a load, comprising:
a step-up circuit, utilized to receive an input voltage and to increase the input voltage in order to generate an output voltage and further control the output voltage based on a feedback voltage representing state of the load; and
a modulation circuit, coupled to the step-up circuit and transforming the output voltage into the driving voltage with a voltage level higher than that of the output voltage.

2. The DC voltage converter according to claim 1, wherein the modulation circuit is a charge pump step-up circuit.

3. The DC voltage converter according to claim 2, wherein the step-up circuit comprises:
a first capacitor;
an inductor, which receives the input voltage;
a power transistor, in which a source/drain of the power transistor is coupled to the inductor;
a pulse-width modulation control unit, controlling switching between on/off states of the power transistor by using a gate voltage so as to manipulate charging and discharging operations of both the first capacitor and the inductor to generate the output voltage; and
a first diode, in which the a positive end of the first diode is coupled to a junction between the source/drain of the power transistor and the inductor, and a negative end of the first diode is coupled to one end of the first capacitor, while the other end of the first capacitor is grounded.

4. The DC voltage converter according to claim 3, wherein the pulse-width modulation control unit further comprises:
an error amplifier, which compares the feedback voltage with a reference voltage to generate an error signal; and
a comparator, coupled to the error amplifier and the power transistor for comparing the error signal with a slope signal to generate the gate voltage.

5. The DC voltage converter according to claim 3, wherein the power transistor is an N-type Metal Oxide Semiconductor Field Effect Transistor (N MOSFET).

6. The DC voltage converter according to claim 3, wherein the modulation circuit further comprises:
a second diode, in which a positive end of the second diode is utilized to receive a power source voltage;
a second capacitor, in which one end of the second capacitor is coupled to the positive end of the first diode, and the other end of the second capacitor is coupled to a negative end of the second diode;
a third diode, in which a positive end of the third diode is coupled to a junction between the negative end of the second diode and the second capacitor; and
a third capacitor, in which one end of the third capacitor is coupled to a negative end of the third diode and the load to transfer the driving voltage to the load, and the other end of the third capacitor is grounded.

7. The DC voltage converter according to claim 3, wherein the modulation circuit further comprises:
a second diode, in which a positive end of the second diode is utilized to receive the output voltage;
a third diode, in which a negative end of the third diode is coupled to the load to transfer the driving voltage to the load; and
a second capacitor, in which one end of the second capacitor is coupled to the positive end of the first diode, and the other end of the second capacitor is coupled to a positive end of the third diode and a negative end of the second diode.

8. The DC voltage converter according to claim 7, wherein the modulation circuit further comprises:
a third capacitor, which is coupled to the negative end of the second diode and a junction between the second capacitor and the third diode.

9. The DC voltage converter according to claim 2, wherein the load comprises at least one white-light-emitting-diode (WLED) and a resistor, in which the WLED is coupled in serial with the resistor, a positive end of the WLED is coupled to an output end of the modulation circuit to receive the driving voltage, a negative end of the WLED is coupled to one end of the resistor, while the other end of the resistor is grounded, and the step-up circuit is coupled to a junction between the negative end of the WLED and the resistor to receive the feedback voltage.

10. The DC voltage converter according to claim 1, wherein the step-up circuit comprises:
a first capacitor;
an inductor, which receives the input voltage;
a pulse-width modulation control unit, having a power transistor, in which a source/drain of the power transistor is connected to the inductor, and the pulse-width modulation control unit controlling switching between on/off states of the power transistor by using a gate voltage so as to manipulate charging and discharging operations of both the first capacitor and the inductor to generate the output voltage; and
a first diode, in which a positive end of the first diode is coupled to a junction between the source/drain of the power transistor and the inductor, and a negative end of the first diode is coupled to one end of the first capacitor, while the other end of the first capacitor is grounded.

11. The DC voltage converter according to claim 10, wherein the pulse-width modulation control unit further comprises:
an error amplifier, which compares the feedback voltage with a reference voltage to generate an error signal; and
a comparator, coupled to the error amplifier and the power transistor for comparing the error signal with a slope signal to generate the gate voltage.

12. The DC voltage converter according to claim 10, wherein the modulation circuit further comprises:
a second diode, in which a positive end of the second diode is utilized to receive a power source voltage;
a second capacitor, in which one end of the second capacitor is coupled to the positive end of the first diode, and the other end of the second capacitor is coupled to a negative end of the second diode;
a third diode, in which the positive end of the third diode is coupled to a junction between the negative end of the second diode and the second capacitor; and
a third capacitor, in which one end of the third capacitor is coupled to a negative end of the third diode and the load so as to transfer the driving voltage to the load, and the other end of the third capacitor is grounded.

13. The DC voltage converter according to claim 10, wherein the modulation circuit further comprises:
a second diode, in which a positive end of the second diode is utilized to receive the output-voltage;
a third diode, in which a negative end of the third diode is coupled to the load to transfer the driving voltage to the load; and
a second capacitor, in which one end of the second capacitor is coupled to the positive end of the first diode, and the other end of the second capacitor is coupled to a positive end of the third diode and a negative end of the second diode.

14. The DC voltage converter according to claim 13, wherein the modulation circuit further comprises:
a third capacitor, coupled to the negative end of the second diode and a junction between the second capacitor and the third diode.
